(19) United States
(12) Patent Application Publication
(10) Pub. No.: US 2022/0316610 A1
(43) Pub. Date: Oct. 6, 2022

(54) SANITARY FITTING

(71) Applicant: Flühs Drehtechnik GmbH, Luedenscheid (DE)

(72) Inventor: Lutz LANGE, Luedenscheid (DE)

(73) Assignee: Flühs Drehtechnik GmbH, Luedenscheid (DE)

(21) Appl. No.: 17/625,137

(22) PCT Filed: May 5, 2021
(86) PCT No.: PCT/EP2021/061897

§ 371 Date: Jan. 6, 2022

(30) Foreign Application Priority Data
Jun. 5, 2020 (EP) 20178439.4

(51) Int. Cl. F16K 11/22; F16K 15/06

(52) U.S. Cl. CPC F16K 11/22; F16K 15/063

(57) ABSTRACT

A sanitary fitting, more particularly a thermostatic mixing valve, includes a housing, which has a valve seat for receiving a valve and into which at least one feed channel and a discharge channel open, wherein the at least one feed channel is led through a chamber, into which a backflow preventer is inserted and which is closed by a plug. A retaining frame is provided on the plug, which retaining frame protrudes into the chamber and by which retaining frame the backflow preventer is axially fixed.

The invention relates to a sanitary fitting, in particular a thermostatic mixing fitting in accordance with the preamble of claim 1.

Exit of media from fittings is controlled using shut-off valves or mixing valves. For this purpose, the valve is screwed into a valve holder or a valve seat of the fitting, into which seat at least one water feed channel and one water discharge channel open. Such valves for sanitary fittings are known in the most varied embodiments. Frequently thermostatic mixing valves are used here, which have an adjustable thermo-element, by way of which the inflow of hot water from a first feed channel and of cold water from a second feed channel can be controlled. The desired water temperature is achieved by means of the corresponding mixing ratio of hot and cold water.

In order to prevent backflow of water situated in the fitting into the feed lines in the event of a pressure drop, it is absolutely necessary, in the case of potable water installations, to provide what are called check valves. In this regard, this is a valve body having a piston that is pre-loaded against the water inflow direction by way of a spring. This piston is opened by means of the water pressure, so that the water can flow into the valve by way of the corresponding feed line. If the water pressure drops below a minimum pressure that is required to move the piston counter to the spring pre-load, the piston is moved against a seal seat, by way of the spring, using a sealing cone formed on it, and thereby backflow of the water situated in the fitting into the feed channel is prevented.

For positioning of a check valve, a chamber to hold it is assigned to each feed channel, in the fitting of the valve holder, ahead of the channel. In order to guarantee a locally fixed seat of the check valve, the latter is provided with engagement projections that engage into an engagement groove arranged in the wall of the chamber when the check valve is introduced, and thereby the check valve is anchored in the wall of the chamber.

It is a disadvantage of this previously known arrangement that removal of an inserted check valve from the chamber, in order to replace it, is complicated, since the engagement projections can be moved out of the engagement groove only with difficulty or not at all. For this reason, the engagement projections are often destroyed during the course of removal of the check valve, and after that happens, broken-off engagement projections remain in the chamber or get into the feed channel. These engagement projection parts can lead to damage to seals or also to preventing the introduction of a new check valve.

This is where the invention seeks to provide a remedy. The invention is based on the task of making available a sanitary fitting of the above type, in which simple, destruction-free removal of a check valve is made possible. According to the invention, this task is accomplished by means of a sanitary fitting having the characteristics of the characterizing part of claim 1.

With the invention, a sanitary fitting is made available in which simple, destruction-free removal of a check valve is made possible. Because of the fact that a retaining frame is provided on the plug, which frame protrudes into the chamber and by means of which frame the check valve is axially fixed in place, the anchoring of engagement projections formed on the check valve in the wall of the chamber, as known from the state of the art, is not required. The check valve can be brought into its position using the retaining frame, by way of the plug, and is fixed in place there by way of the retaining frame.

In a further development of the invention, the at least one check valve introduced into a chamber has at least one seal, by way of which it is sealed off relative to the chamber. The check valve can be positioned with precise fit in the chamber, by way of the seal, by way of the retaining frame of the plug, forming a seal.

In an embodiment of the invention, at least one check valve has a movable piston by way of which the check valve can be closed in the backflow direction, in other words in the direction of the water inflow, wherein a shut-off element is arranged in the assigned plug of the chamber in which the check valve is positioned, for moving the piston into its closed position, in other words into the position in which it lies against the seal seat of the check valve, forming a seal, and thereby preventing water inflow. In this way, simple shut-off of a feed channel, for example for replacement of the valve of the sanitary fitting, is made possible. By means of the shut-off element, the piston is brought into the closed position, counter to the water pressure that exists in the feed line, and held there. Preferably the shut-off element is mounted so that it can move axially in the direction of the piston through a bore arranged in the plug, and can be fixed in place at least in a position in which it lies against the piston in the closed position.

In a further embodiment of the invention, the shut-off element has an outside thread, in certain regions, which thread engages into an inside thread of the plug, and thereby the shut-off element can be moved axially into the plug by means of rotation. In this way, a defined movement of the piston of the check valve by way of a screwing or unscrewing movement of the shut-off element is made possible, and this element can thereby be brought into contact with the piston.

In a further development of the invention, the shut-off element has a head that is preferably enlarged in diameter, and has the outside thread, wherein an engagement location for a turning tool is present in the head. In this way, movement of the shut-off element by way of a screwdriver or also an Allen wrench is made possible. By means of providing a special engagement location, such as a torx or hex socket engagement location, for example, activation of the shut-off element by unauthorized persons is counteracted.

In an embodiment of the invention, the shut-off element has a cylindrical section that lies against a seal, in particular an O-ring, through which it passes and by way of which it is sealed off relative to the plug. In this way, continuous guidance and sealing of the shut-off element relative to the plug is achieved even during an axial movement.

In a further development of the invention, the plug has an outside thread with which it is screwed into an inside thread of an antechamber. In this way, reliable fixation of the plug in the fitting is achieved. By means of the screw-in movement of the plug, uniform advancement of the retaining frame arranged on it, and with this of the check valve that lies against it, is brought about. Preferably the retaining frame of the plug is configured as a hollow cylinder, and has at least one window for water to pass through.

In an embodiment of the invention, the retaining frame has a holder on its end side, by way of which the check valve is framed. In this way, reliable fixation of the check valve in the chamber in which it is positioned is achieved. Preferably the holder is formed by a ring-shaped step.

In a further embodiment of the invention, the check valve is arranged, at least in certain regions, preferably in the region of its upper half, which faces the plug, at a distance from the wall of the chamber, and thereby a gap is formed, at least in certain regions, preferably circumferentially, into which gap the holder of the retaining frame engages. In this way, axial fixation of the check valve is achieved.

In a preferred embodiment of the invention, the valve is a thermostatic valve, wherein a cold water inflow and a hot water inflow open into the valve space, each of them connected with a water feed channel of the thermostatic valve, forming a seal. In this regard, preferably both the cold water inflow and the hot water inflow are passed through an antechamber into which a check valve is introduced.

Other further developments and embodiments of the invention are indicated in the remaining dependent claims. An exemplary embodiment of the invention is shown in the drawings and will be described in detail below. The figures show:

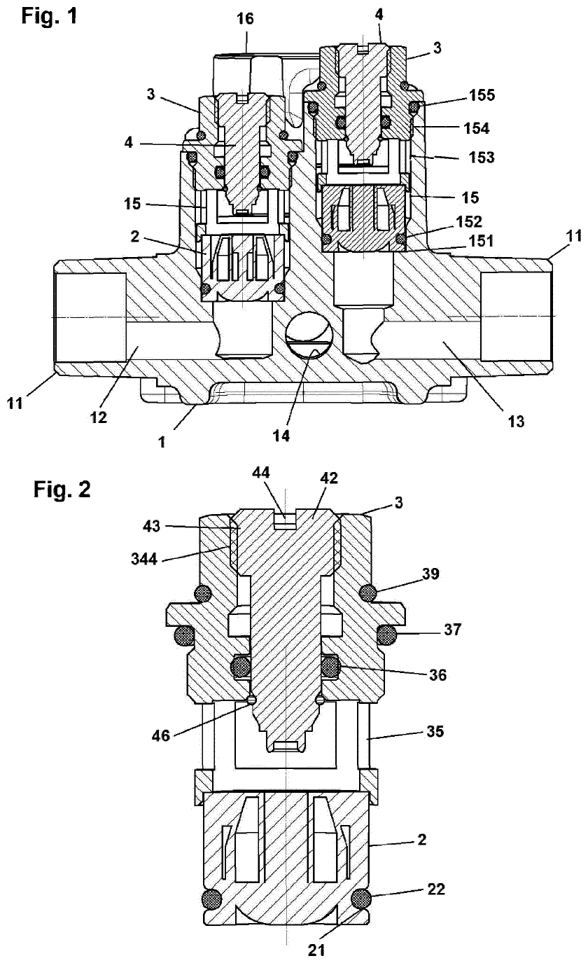

FIG. 1 the schematic representation of a thermostatic mixing fitting;

FIG. 2 the schematic representation of a plug of the thermostatic mixing fitting from FIG. 1, with a check valve held by it;

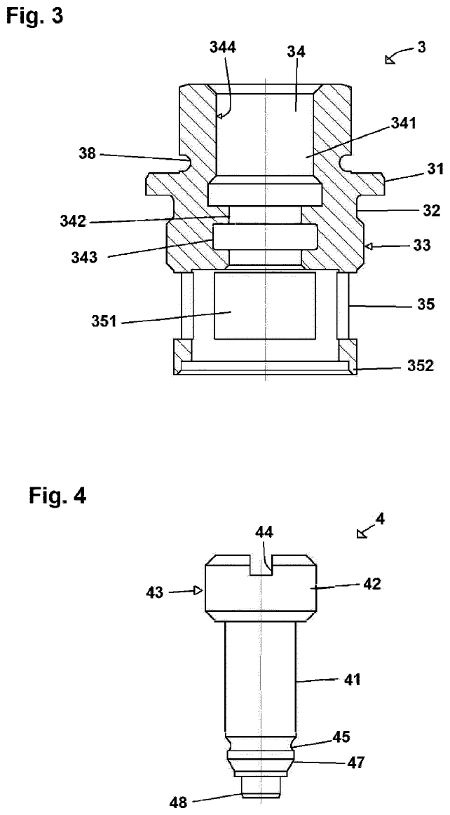

FIG. 3 the detail representation of the plug of the arrangement from FIG. 2 in longitudinal section;

FIG. 4 the detail view of the shut-off valve of the arrangement from FIG. 2;

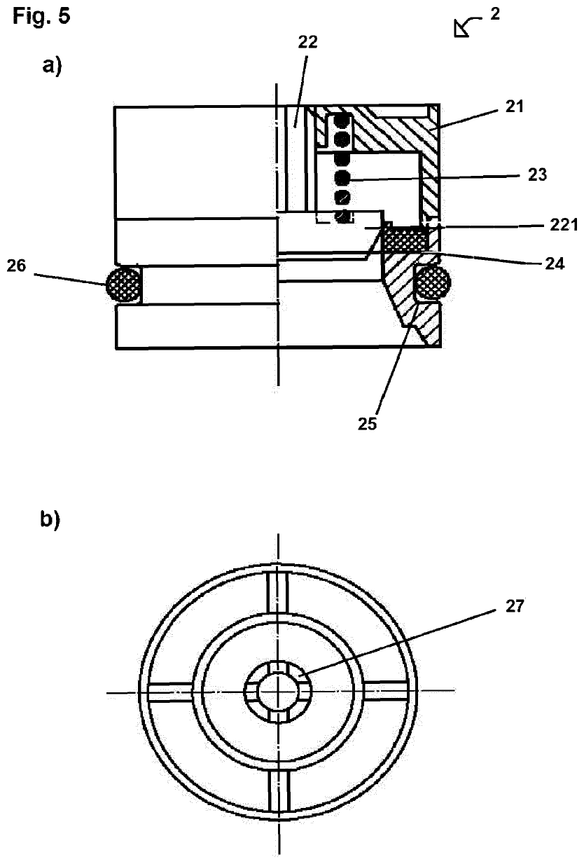

FIG. 5 the representation of the check valve of the arrangement from FIG. 2
a) in partial section, and
b) in a top view.

The thermostatic mixing fitting selected as an exemplary embodiment comprises a housing 1 having a valve seat 16, which holds a thermostatic valve—not shown. Three connection pieces 11 for connection of water lines—not shown—are formed on the housing 1, by means of which a hot water feed channel 12, a cold water feed channel 13 arranged opposite to it, and a discharge channel 14 that runs between them are passed and open into the valve seat 16. In this regard, the hot water feed channel 12 and the cold water feed channel 13 are each connected with an inflow of the thermostatic valve, and the discharge channel 14 is connected with the discharge of the thermostatic valve.

The hot water feed channel 12 and the cold water feed channel 13 are each passed through a chamber 15 that precedes the valve seat 16, which chamber holds a check valve 2, in each instance. The chambers 15 are arranged axially offset from one another and each structured in the form of a stepped bore, which opens into the corresponding water feed channel 12, 13, in each instance. In the transition to the corresponding water feed channel 12, 13, a step 151 is formed, followed by a first cylindrical section 152, which makes a transition to a second section 153, which is widened in diameter and provided with an inside thread 154 on the end side, which thread is delimited, on the end side, by a chamfer 155 for sealing contact of an 0-ring 37. The first cylindrical section 152 extends to approximately half the height of the check valve 2, which lies against the step 151.

The check valve 2 comprises, in a usual manner, a cylindrical housing 21, in which a piston 22, provided with a conical piece 221 on its end side, is displaceably guided, and pre-loaded against a seal seat 24 of the housing 21 by way of a pressure spring 23. On the outside, a ring groove 25 for holding an O-ring 26 is introduced into the housing 21. For the remainder, the housing 21 has a smooth mantle surface. No engagement projections or other means for a shape-fit connection with the wall of the chamber 15 are present.

The plug 3 is essentially formed in cylindrical shape and has a ring-shaped collar 31 approximately in the center on the outside, which collar delimits a circumferential groove 32 that makes a transition into an outside thread 33. A stepped bore 34 is introduced into the plug 3, centered axially. The stepped bore 34 has a first section 341 that is provided with an inside thread 344 on its end facing away from the outside thread 33, and is followed by a second section 342, reduced in diameter, which is provided, in its center, with a ring groove 343 for holding an O-ring 36. The second section 342 extends approximately over the region of the plug 3 that is provided with the outside thread 33. On its side that lies opposite the circumferential groove 32, the collar 31 is delimited by a ring groove 38 for holding an O-ring 39.

A retaining frame 35 essentially in the form of a hollow cylinder is formed on the plug 3, which frame is provided with two windows 351 arranged to lie opposite one another, for water to pass through. On the end side, a ring-shaped step 352 is formed on the retaining frame 35, by means of which step a holder for the check valve 2 is formed.

The shut-off element 4 comprises a cylindrical body 41, on which a cylindrical head 42, widened in diameter, is formed on the end side, which head is provided with an outside thread 43. A Phillips tool engagement location 44 is introduced into the head 42. On its end that lies opposite the head 42, a key groove 45 for holding an O-ring 46 is introduced into the cylindrical body 41, followed by a section 47 in the form of a truncated cone, on which a cylindrical connecting piece 48 is formed.

A check valve 2 is introduced into the two chambers 15 of the housing 1, in each instance, in such a manner that they lie against the step 151 of the chamber 15, wherein its piston 22 is pre-loaded in the direction of the corresponding water feed channel 12, 13, against the seal seat 24. The two chambers 15 are each closed off by way of a plug 3, which is screwed into the inside thread 154 of the chamber 15 with its outside thread 33, wherein the O-ring 37 lies against the chamfer 155 of the chamber 15, forming a seal. In this regard, the retaining frame 35 of each plug 3 lies on the housing 21 of the corresponding check valve 2 that is framed by the ring-shaped step 352, which engages into the gap formed between the check valve 2 and the wall of the first cylindrical section 151 of the corresponding chamber 15. The check valve 2 is thereby securely held between the step 151 of the chamber 15 and the retaining frame 35 of the plug 3. To replace the check valve 2, the plug 3 only has to be removed; subsequently, the valve can simply be taken out and replaced with a new check valve 2.

The shut-off element 4 is introduced into the stepped bore 34 of the plug 3, wherein the head 42 is screwed into the inside thread 344 of the stepped bore 34 with its outside thread 43. In this regard, the cylindrical body 41 is guided in the second section 342 provided with the O-ring 36, forming a seal, wherein the O-ring 46 arranged in the key groove 45 lies against the plug 3. The shut-off element 4 is moved in the direction of the check valve 2 by turning the shut-off element 4 clockwise, by way of a Phillips screwdriver that engages into the tool engagement location 44 of the head 42, until the connecting piece 47 engages into an engagement location 27 provided in the piston 22 for this purpose.

By means of further rotation of the shut-off element 4, the piston 22 can be moved against the seal seat 24 with its conical piece 221, and thereby the corresponding water feed channel 12, 13 is closed off, forming a seal. By way of the threaded engagement location of the shut-off element 4, this element can furthermore be used to limit the amount of the corresponding stream of water into the hot water feed channel 12 or the cold water feed channel 13, respectively, in that the piston 22 is not completely set onto the seal seat 24 with its conical piece 221.

1. A sanitary fitting, in particular a thermostatic mixing fitting, having a housing (1) that has a valve seat (16) for holding a valve, and into which seat at least one feed channel (12, 13) and a discharge channel (14) open, wherein the at least one feed channel (12, 13) is passed through a chamber (15), into which a check valve (2) is introduced, and which is closed off by way of a plug (3), wherein a retaining frame is provided on the plug (3), which frame protrudes into the chamber (15) and by means of which frame the check valve (2) is axially fixed in place.

2. The sanitary fitting according to claim 1, wherein the at least one check valve (2) introduced into a chamber (15) has at least one seal (5), by way of which it is sealed off relative to the chamber (15).

3. The sanitary fitting according to claim 1, wherein the at least one check valve (2) has a movable piston (22), by way of which it can be closed in the backflow direction, wherein a shut-off element (4) is arranged for moving the piston (22) of the check valve (2) into its closed position is provided in the related plug (3).

4. The sanitary fitting according to claim 3, wherein the shut-off element (4) is mounted so that it can move axially in the direction of the piston (22) of the check valve (2) through a bore (34) arranged in the plug (3), and can be fixed in place at least in a position in which it lies against the piston (22) in its closed position.

5. The sanitary fitting according to claim 4, wherein the shut-off element (4) has an outside thread (43), in certain regions, which thread engages into an inside thread (344) of the plug (3), and thereby the shut-off element (4) can be moved axially in the plug (3) by means of rotation.

6. The sanitary fitting according to claim 5, wherein the shut-off element (4) has a head (42) that is preferably enlarged in diameter, which head has the outside thread (43), wherein an engagement location (44) for a turning tool is present in the head (42).

7. The sanitary fitting according to claim 3, wherein the shut-off element (4) has a cylindrical section (41) that lies against a seal (37) through which it passes and by way of which it is sealed off relative to the plug (3).

8. The sanitary fitting according to claim 1, wherein the plug (3) has an outside thread (33), with which it is screwed into an inside thread (154) of a chamber (15).

9. The sanitary fitting according to claim 1, wherein the retaining frame (35) of the plug (3) is configured as a hollow cylinder, and has at least one window (351) for water to pass through.

10. The sanitary fitting according to claim 9, wherein the retaining frame (35) has a holder on its end side, by way of which the check valve (2) is framed.

11. The sanitary fitting according to claim 10, wherein the holder is formed by a ring-shaped step (352).

12. The sanitary fitting according to claim 9, wherein the check valve (2) is arranged, at least in certain regions, preferably in the region of its upper half, which faces the plug (3), at a distance from the wall of the chamber (15), whereby a gap is formed, at least in certain regions, preferably circumferentially, into which gap the holder of the retaining frame (35) engages.

13. The sanitary fitting according to claim 1, wherein a thermostatic valve is introduced into the valve seat (16), wherein a hot water inflow (12) and a cold water inflow (13) open into the valve seat (16), each of them being connected with a water feed channel of the thermostatic valve, forming a seal.
